(19) United States
(12) Patent Application Publication
(10) Pub. No.: US 2014/0279622 A1
(43) Pub. Date: Sep. 18, 2014

(54) SYSTEM AND METHOD FOR SEMANTIC PROCESSING OF PERSONALIZED SOCIAL DATA AND GENERATING PROBABILITY MODELS OF PERSONAL CONTEXT TO GENERATE RECOMMENDATIONS IN SEARCHING APPLICATIONS

(71) Applicants: Sudhakar Bharadwaj, McKinney, TX (US); Michael G. Lamoureux, (US)

(72) Inventors: Michael G. Lamoureux, Williamswood (CA); Sudhakar Bharadwaj, McKinney, TX (US)

(21) Appl. No.: 14/201,619

(22) Filed: Mar. 7, 2014

Related U.S. Application Data
(60) Provisional application No. 61/774,677, filed on Mar. 8, 2013.

(51) Int. Cl. G06Q 10/10; G06Q 50/00

(52) U.S. Cl. CPC G06Q 10/1053; G06Q 50/01
USPC 705/319

(57) ABSTRACT

A method and system for searching for employment opportunities. The method includes searching a plurality of webpages on websites for the employment opportunities and processing the webpages to determine semantic information about the employment opportunities including at least an employer for each of the employment opportunities. The method also includes identifying social network connections of a user and searching information from one or more social network websites to identify at least one of a current or previous employer of one or more of the social network connections of the user. Additionally, the method includes, in response to receiving a query from a user, returning a list of potential employment opportunities including information about one or more of the social network connections of the user identified as currently or previously employed or associated with a current or previous employee of an employer of one or more of the potential employment opportunities.

### CROSS-REFERENCE TO RELATED APPLICATION(S) AND CLAIM OF PRIORITY

The present application claims priority under 35 U.S.C. §119(e) to U.S. Provisional Patent Application Ser. No. 61/774,677 filed Mar. 8, 2013 and entitled “SYSTEM AND METHOD FOR SEMANTIC PROCESSING OF PERSONALIZED SOCIAL DATA, AND GENERATING PROBABILITY MODELS OF PERSONAL CONTEXT TO GENERATE RECOMMENDATIONS IN SEARCHING APPLICATIONS.” The above-identified provisional patent application is hereby incorporated by reference in its entirety.

### TECHNICAL FIELD

The present disclosure relates generally to searching applications and, more specifically, to semantic processing of data extracted from the Internet to generate recommendations in searching applications.

### BACKGROUND

Considerable effort to date has been placed on addressing the problem of searching for and extracting relevant information from large volumes of data which is available through today's on-line communications networks. The general solution set is based on the concept of information filtering using relevance as the test criteria. One challenge is that relevance is assessed at the level of the individual information consumer, but the factors which contribute to establishing relevance may extend beyond the consumer's personal tastes or views to include specific cultural preferences, dialect and vernacular distinctions, and information beyond the consumer's perception of the target topic.

The use of information filtering attempts to solve the generalized problem of extracting useful information from data, which may or may not be relevant, using one of two classes of approach—content-filtering or collaborative filtering.

In the content filtering approach, information is extracted and organized using the properties of the data itself; search engines being the most common example whereby they use pattern matching of keywords to deliver, as a result, a set of data which may have relevance to the requestor. This method of establishing relevance is limited, because this method assumes that both the author of the data and the requestor of the data have the same vernacular, cultural preferences, and understanding of the subject topic—a common context or set of rules by which information is shared. But differences in backgrounds, education, culture, language, or domain knowledge erode this common context. As a result, such pattern matching or keyword tests are often unsuccessful when the author of data and the requestor of the data use two different words or phrases that, contextually, are the same.

In the collaborative filtering approach, information is extracted based on the requestor's previous behaviors or stated preferences. Electronic commerce (e-commerce) sites commonly use this approach to make recommendations based on their relationship with the user, looking at previous transactions as a predictor of behaviors, and making recommendations based on other users who have demonstrated a similar interest in a product or service. This social grouping is an improvement over the content-based filtering approach in that collaborative filtering attempts to personalize the data based on an understanding of the user. However, this approach is also limited because, much like content filtering, there is a requirement for a recommendation to be based on a common context. Even in cases where there are other users who may have demonstrated a similar interest in a product or service, the association of a user with a group of products based on other user's needs deprecates the individual context of the user in favor of a categorization of the user as belonging to a group of users on the assumption of similar utility in the recommended product or service.

Accordingly, it would be advantageous to have systems and methods that take into account one or more of the issues discussed above, as well as possibly other issues.

### SUMMARY

The different illustrative embodiments provide semantic processing of personalized social data and generating probability models of personal context to generate recommendations in searching applications.

According to one exemplary embodiment of the present disclosure, a method for searching for employment opportunities is provided. The method includes searching a plurality of webpages on a plurality of websites for the employment opportunities and processing the webpages to determine information about the employment opportunities including at least an employer for each of the employment opportunities. The method also includes identifying social network connections of a user and searching information from one or more social network websites to identify at least one of a current or previous employer of one or more of the social network connections of the user. Additionally, the method includes in response to receiving a query from a user, returning a list of potential employment opportunities including information about one or more of the social network connections of the user identified as currently or previously employed or associated with a current or previous employee of an employer of one or more of the potential employment opportunities.

According to another exemplary embodiment of the present disclosure, a system for searching for employment opportunities is provided. The system comprises a storage device configured to store program code, a communication unit, and a processing unit. The processing unit is configured to execute the program code to search, via the communication unit, a plurality of webpages on a plurality of websites for the employment opportunities; process the webpages to determine information about the employment opportunities including at least an employer for each of the employment opportunities; identify social network connections of a user; search, via the communication unit, information from one or more social network websites to identify at least one of a current or previous employer of one or more of the social network connections of the user; and in response to receiving a query from a user, return, via the communication unit, a list of potential employment opportunities including information about one or more of the social network connections of the user identified as currently or previously employed or associated with a current or previous employee of an employer of one or more of the potential employment opportunities.

According to another exemplary embodiment of the present disclosure, a computer readable medium comprising program code for searching for employment opportunities is provided. The non-transitorily computer readable medium includes program code for searching a plurality of webpages on a plurality of websites for the employment opportunities; processing the webpages to determine information about the employment opportunities including at least an employer for each of the employment opportunities; identifying social network connections of a user; searching information from one or more social network websites to identify at least one of a current or previous employer of one or more of the social network connections of the user; and in response to receiving a query from a user, returning a list of potential employment opportunities including information about one or more of the social network connections of the user identified as currently or previously employed or associated with a current or previous employee of an employer of one or more of the potential employment opportunities.

Other technical features may be readily apparent to one skilled in the art from the following figures, descriptions, and claims.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example computing system in which various embodiments of the present disclosure may be implemented;

FIG. 2 illustrates a block diagram of a system for extracting semantic information from various data sources utilizing a semantic framework in accordance with an illustrative embodiment of the present disclosure;

FIG. 3 illustrates a block diagram of a system for a heuristic assessor within the semantic framework to process the source data to generate semantic information in accordance with an illustrative embodiment of the present disclosure;

FIG. 4 illustrates a flowchart of a process for extracting semantic information from various data sources utilizing a semantic framework in an example embodiment of searching for employment in accordance with an illustrative embodiment of the present disclosure;

FIG. 5 illustrates a block diagram of a semantic, job search, and aggregation system in accordance with an illustrative embodiment of the present disclosure;

FIG. 6 illustrates a block diagram of an example aggregator system that may be used in the semantic, job search, and aggregation platform illustrated in FIG. 5;

FIG. 7 illustrates a block diagram of another example aggregator system that may be used in the semantic, job search, and aggregation platform illustrated in FIG. 5;

FIG. 8 illustrates a block diagram of a semantic, job search, and aggregation system implemented with a mobile platform and recommendation engine in accordance with an illustrative embodiment of the present disclosure;

FIG. 9 illustrates a block diagram of a multi-lingual parser framework system in accordance with an illustrative embodiment of the present disclosure;

FIG. 10 illustrates a block diagram of one example of a keyword generation and annotation framework system in accordance with an illustrative embodiment of the present disclosure;

FIG. 11 illustrates a block diagram of a heuristic query processing system in accordance with an illustrative embodiment of the present disclosure;

FIG. 12 illustrates an example of a user interface for displaying job search results to a user in accordance with an illustrative embodiment of the present disclosure;

FIG. 13 illustrates an example of a user interface for sending a message to a social network connection for assistance in a job search in accordance with an illustrative embodiment of the present disclosure; and

FIG. 14 illustrates a block diagram of a computing device which may be utilized to implement various embodiments of the present disclosure.

### DETAILED DESCRIPTION

The various figures and embodiments used to describe the principles of the present disclosure in this patent document are by way of illustration only and should not be construed in any way to limit the scope of the present disclosure. Those skilled in the art will understand that the principles of the present disclosure may be implemented in any type of suitably arranged device or system.

The present disclosure incorporates by reference the following documents:

1) U.S. Pat. No. 6,687,696 B2, issued February 2004 to Hoffman et al.;

2) U.S. Pat. No. 7,328,216 B2, issued February 2008 to Hoffman et al.;

3) U.S. Pat. No. 7,783,642 B1, issued August 2010 to Feng et al.;

4) U.S. Pat. No. 7,809,721 B2, issued October 2010 to Putivsky et al.;

5) U.S. Pat. No. 8,060,513 B2, issued November 2011 to Basco et al.;

6) U.S. Pat. No. 7,822,699 B2, issued October 2010 to Katariya et al.;

7) U.S. Pat. No. 8,285,728 B1, issued October 2012 to Rubin;

8) U.S. Pat. No. 8,335,778 B2, issued December 2012 to Ghosh et al.;

9) U.S. Pat. No. 8,055,669 B1, issued November 2011 to Singhal et al.;

10) U.S. Pat. No. 7,593,845, issued September 2009 to Ramsay;

11) U.S. Pat. No. 7,877,349, issued January 2011 to Huet et al.;

12) U.S. Pat. No. 7,996,211, issued October 2011 to Gao et al.;

13) U.S. Pat. No. 8,073,794, issued December 2011 to Amer-Yahia et al.

14) Lamoureux, White, “Proposal for Participation In the Development of the JobHound Universal Semantic Search Technology Platform (JUSST)”, Industrial Research Assistance Programme, National Research Council, Government of Canada (IRAP), Project 736200, Mar. 16, 2010;

15) Abadi, Marcus, Madden, & Hollenbach, “Scalable Semantic Web Data Management Using Vertical Partitioning”, VLDB '07, Sep. 23-28, 2007, Vienna, Austria.

16) Abiteboul, Preda, & Cobena, “Adaptive On-Line Page Importance Computation”, WWW2003, ACM 1-58113-680-Mar. 3, 0005;

17) Aleman-Meza, Nagarajan, Ramakrishnan, Ding, Kolari, Sheth, Arpinar, Joshi, & Finn, “Semantic Analytics on Social Networks: Experiences in Addressing the Problem of Conflict of Interest Detection”, Proceedings of the 15th international conference on World Wide Web (2006), pp. 407-416;

18) Amardeilh, “Semantic Annotation and Ontology Population”, Semantic Web Engineering in the Knowledge Society, Chapter VI, Information Science Reference, ISBN: 978-1-60566-112-4;

19) An, Borgida, & Mylopoulos, “Finding Semantic Mappings from Relational Tables to Ontologies/Conceptual Models”, ODBASE 2005, volume 3760 of Lecture Notes in Computer Science;

20) Bar-Yossef and Rajagopalan, “Template Detection via Data Mining and its Applications”, Proceedings of the 11th International Conference on World Wide Web, 2002, Pages 580-591, ISBN:1-58113-449-5;

21) Bernardi, Decker, van Elst, Grimnes, Groza, Handschuh, Jazayeri, Mesnage, Moller, Reif, Sintek, & Sauermann, “The Social Semantic Desktop: A New Paradigm Towards Deploying the Semantic Web on the Desktop”, Semantic Web Engineering in the Knowledge Society, Chapter XII, Information Science Reference, ISBN: 978-1-60566-112-4;

22) Chen, Santamaria, Butz, Theron, “TagClusters: Semantic Aggregation of Collaborative Tags beyond TagClouds”, International Journal of Creative Interfaces and Computer Graphics (IJCICG)”, ISSN: 1947-3117, IGI global, 2010;

23) Dai and Mobasher, “Integrating Semantic Knowledge with Web Usage Mining for Personalization”, Web Mining: Applications and Techniques, Anthony Scime (ed.), IRM Press, Idea Group Publishing. 2005;

24) D'Aquin, Sabou, & Motta, “Modularization: a Key for the Dynamic Selection of Relevant Knowledge Components”, Proceedings First International Workshop on Modular Ontologies (WoMO-2006);

25) Dolby, Fokoue, Kalyanpur, Kershenbaum, Schonberg, Srinivas, & Ma, “Scalable Semantic Retrieval through Summarization and Refinement”, 21st Conference on Artificial Intelligence (AAAI 2007), pp. 299-304, 2007;

26) Ermolayev, Kerbele, Plaksin, & Vladimirov, “Capturing Semantics from Search Phrases: Incremental User Personification and Ontology-Driven Query Transformation”, Proc. of the 2nd Int. Conf. on Information Systems Technology and its Applications, 2003;

27) Farahat and Kamel, “Enhancing Document Clustering Using Hybrid Models for Semantic Similarity”, Proceedings of the Eighth Workshop on Text Mining at the Tenth SIAM International Conference on Data Mining, 2010;

28) He, Gu, Luo, Yan, Stankovic, Son, “An Overview of Data Aggregation Architecture for Real-Time Tracking with Sensor Networks”, Proceedings of the 20^{th} international conference on Parallel and distributed processing, 2006;

29) Jin and Mobasher, “Using Semantic Similarity to Enhance Item-Based Collaborative Filtering”, 2nd IASTED Int Conf on Information and Knowledge Sharing, 2003;

30) Li, Wang, Zhang, Zhang, & Chang, “PFP: Parallel FP-Growth for Query Recommendation”, Proceedings of the 2008 ACM conference on Recommender systems (RecSys '08);

31) Lowerison & Lowerison, “Increasing the Accuracy of Wild Searches Using Semantic Knowledge Engine and Semantic Archivist”, WikiSym '09, Oct. 25-27, 2009, Orlando, Fla., U.S.A.;

32) Matyas, “Collaborative Spatial Data Acquisition—A Spatial and Semantic Data Aggregation Approach”, 10th AGILE International Conference on Geographic Information Science 2007;

33) Mika, “Flink: Semantic Web Technology for the Extraction and Analysis of Social Networks”, Web Semantics: Science, Services and Agents on the World Wide Web, Vol. 3, No. 2-3. (October 2005), pp. 211-223;

34) Mika, “Ontologies are us: A unified model of social networks and semantics”, Journal of Web Semantics, Elsevier, Volume 5, Number 1, p. 5-15 (2007);

35) Mobasher, Dai, Luo, and Nakagawa, “Discovery and Evaluation of Aggregate Usage Profiles for Web Personalization”, Data Mining and Knowledge Discovery, 6, 61-82;

36) Rodriguez and Egenhofer, “Determining Semantic Similarity Among Entity Classes from Different Ontologies”, IEEE Transactions on Knowledge and Data Engineering 15(), 442-256; and

37) Villa, “A semantic framework and software design to enable the transparent integration, reorganization and discovery of natural systems knowledge”, Journal of Intelligent Information Systems, Volume 29 Issue 1, August 2007.

Various embodiments of the present disclosure recognize and take into account that a problem of establishing a common context is central to improvements in the state of the art in information filtering. In answer to this, the development of methods and systems which rely on semantic knowledge—a learned common context through the extraction of meaning—has evolved. Semantic knowledge and associated methods and techniques have been used to extract meaning from content in an attempt to improve relevance over the pattern matching and similar techniques of the content filtering approach. However, various embodiments of the present disclosure recognize and take into account that there remains a deficiency in the application of semantic knowledge methods and systems to extract meaning from users' behaviors, relationships, and associations to improve relevance based on the requesting user's personal context—some of which may not be defined by the user, but by the user's environment.

Accordingly, various embodiments of the present disclosure provide a novel method for extraction of semantic knowledge from personalized data obtained from on-line social media communications networks and data sources pertaining to employment, educational opportunities, consumer products, and services. Various embodiments of the present disclosure use this semantic knowledge to return, as a result, relevant information and recommendations based on the individual user's identifiable information, information pertaining to their relationships with other users, and information regarding the environment of both the user and their associates including, for example, employment, educational background, interests, and cultural affiliations.

Various embodiments of the present disclosure extract data using a crawling process or direct data interchange through an Application Programming Interface (API) and process the data for semantic elements. These elements may be evaluated using a heuristic assessor that employs multiple types of probabilistic, statistical, and semantic models to examine the multi-dimensional data sources through a family of ontological structures resulting in repositories of structured data. The repositories may be accessed based on a semantic query generated by inputs, and compared against the social media information which has been learned about the user and the user's environment that allows for relevant results to be returned, as well as, personalized recommendations to either improve relevance of the target inquiry, or to alert the user to other information which may relate to the context of the inquiry.

FIG. 1 illustrates an example computing system 100 in which various embodiments of the present disclosure may be implemented. The embodiment of the computing system 100 shown in FIG. 1 is for illustration only. Other embodiments of the computing system 100 could be used without departing from the scope of this disclosure.

As shown in FIG. 1, the system 100 includes a network 102, which facilitates communication between various components in the system 100. For example, the network 102 may communicate Internet Protocol (IP) packets or other information between network addresses. The network 102 may include one or more local area networks (LANs), metropolitan area networks (MANs), wide area networks (WANs), all or a portion of a global network, such as the Internet, or any other communication system or systems at one or more locations.

The network 102 facilitates communications between at least one server 104 and various client devices 106-114. Each server 104 includes any suitable computing or processing device that can provide computing services for one or more client devices. Each server 104 could, for example, include one or more processing devices, one or more memories storing instructions and data, and one or more network interfaces facilitating communication over the network 102.

Each client device 106-114 represents any suitable computing or processing device that interacts with at least one server or other computing device(s) over the network 102. In this example, the client devices 106-114 include a desktop computer 106, a mobile telephone or smartphone 108, a personal digital assistant (PDA) 110, a laptop computer 112, and a tablet computer 114. However, any other or additional client devices could be used in the computing system 100.

In this example, some client devices 108-114 communicate indirectly with the network 102. For example, the client devices 108-110 communicate via one or more base stations 116, such as cellular base stations or eNodeBs. Also, the client devices 112-114 communicate via one or more wireless access points 118, such as IEEE 802.11 wireless access points. Note that these are for illustration only and that each client device could communicate directly with the network 102 or indirectly with the network 102 via any suitable intermediate device(s) or network(s).

As described in more detail below, in accordance with various embodiments of the present disclosure, the server 104 may extract data using a crawling process or direct data interchange through an Application Programming Interface (API) and process the data for semantic elements. The server 104 may evaluate these elements using a heuristic assessor that employs multiple types of probabilistic, statistical, and semantic models to examine the multi-dimensional data sources through a family of ontological structures and store such data in structured data. A user may access, via one of client devices 106-114, the repositories based on a semantic query generated by inputs generated by the client devices 106-114. The server 104 may process and compare the processed input against the social media information, which has been learned about the user and the user's environment to return and provide relevant results, as well as, personalized recommendations to either improve relevance of the target inquiry, or to alert the user to other information which may relate to the context of the inquiry.

Although FIG. 1 illustrates one example of a computing system 100, various changes may be made to FIG. 1. For example, the system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

FIG. 2 illustrates a block diagram of a system 200 for extracting semantic information from various data sources utilizing a semantic framework in accordance with an illustrative embodiment of the present disclosure. In this illustrative embodiment, the system 200 may be implemented on one or more servers, such as the server 104 in FIG. 1. As illustrated, the system 200 obtains data through crawler processes 205 and/or through an API 210 with data repositories (e.g., newsgroups 213, corporate websites 214, search engines 215, employment websites 216, and/or other websites or sources of information accessible over a network, such as the Internet 202). The system 200 obtains, via the crawling and/or on-line search interfaces, source data on employment opportunities from multiple employment information portals, as well as, news related to hiring companies or information related to human resources, such as a book on how to prepare a resume or a course on a skill, such as C++ programming, required for an employment opportunity, such as Software Developer.

The system 200 uses a semantic framework 221, which includes a heuristic assessor 227 and multiple semantic algorithms and techniques 222-226, operating in series and in parallel after the combination of which is dictated by heuristic models which sequence single approach algorithms, such as parse trees or single value decomposition for latent semantic indexing, to refine the learned context.

FIG. 3 illustrates a block diagram for the heuristic assessor 227 within the semantic framework 221 to process the source data to generate semantic information in accordance with an illustrative embodiment of the present disclosure. In this illustrative example, a data source 301 (e.g., a document, a webpage, or text extracted from a webpage or posting) is pre-processed to extract relevant contextual information, as shown in FIG. 2, by applying a dynamic semantic framework 221 to the source data that injects multiple semantic algorithms and techniques 222-226 in sequence and/or parallel using the heuristic assessor 227 to extract context from the data allowing it to overcome the shortcomings of any single algorithm or model. For example, parse trees often fail on poorly formed English when words or phrases are encountered that could be nouns or verbs (hit, tread, walk, etc.), and single value decomposition for latent semantic indexing fails when there are too few or too many keywords, or too many have equal representation. Through the sequencing of multiple methodologies, the chances of properly classifying a webpage into the webpage's resource type and category, but also of identifying the topics of relevance on a page, is greatly enhanced.

The sequencing of algorithms and techniques is decided dynamically based on each identified data source 301. In a traditional semantic indexing approach, an algorithm would be applied to the data to identify the most likely keywords based upon statistical significance or uniqueness. But with this approach, assuming the data was describing a book, the algorithm would be just as likely to pull keywords out of the author's biography as it would the book description and might be just as likely to identify a tertiary topic as a primary one. The heuristic assessor 227 pre-processes the page to identify the sections of text that describe the resource 302, in one example a book, and the sections of text that describe the author 303 and the publisher 304, push only the descriptive text through a semantic indexer 305, to generate a candidate key word set, while simultaneously pushing the descriptive text through a semantic classifier 306, and then pushes the generated candidate keywords and the classification through a semantic profiler 307 that uses the classification to select the keywords of highest relevance. The heuristic assessor 227 identifies one or more classifications 308 within the same document or data source 301, removes those irrelevant to the domain via classification rationalizer 309, and then refines the resulting set into a more relevant semantic description of a resource. The semantic data is stored in a repository (e.g., a database system 310) for later comparison against user queries.

FIG. 4 illustrates a flowchart of a process for extracting semantic information from various data sources utilizing a semantic framework in an example embodiment of searching for employment in accordance with an illustrative embodiment of the present disclosure. In this illustrative example, the system 200 receives a semantic query requesting information on employment opportunities of interest to a user (step 401). The system 200 receives information pertaining to one or more social network credentials and authorization, from the user to access the information contained in the user's personally identifiable social network profile(s) (step 402).

The system 200 accesses the profile information identified in step 402 using a social network manager 405 and processes the profiles using the same or similar processes as discussed above regarding the semantic framework 221, utilizing a dynamic semantic algorithm selection framework in series and in parallel to extract semantic context from the profile information 403 extracted from the user's social network account(s). The system then processes the social profile information 403 to search, access, and semantically process the profiles of friends, associates, and corporate affiliates 404 through multiple levels of connection with the user in an iterative fashion.

The system 200 then retrieves opportunities based on the query from step 401 from the repository 310 and then qualifies the opportunities based on relevance. For example, the system 200 may qualify the opportunities based on the strength of the relationships identified from the profiles of friends, associates, and corporate affiliates 404, as well as a review of the user's skill sets extracted from the profile information 403 extracted from the user's social network account(s) as compared to those identified with the opportunity which has been extracted from the repository 310. The system 200 then returns the resulting dataset for presentation to the user (step 406).

In this example, the system 200 also provides an adjunct processing of the opportunities from the repository 310 and the user's profile information 403 and extracts additional information by considering semantic data extracted from data repositories 213-216 and semantic data located in repository 310, identifies personal context, and provides recommendations (step 407) to improve the probability of compatibility between the user and the opportunity. For example, the system 200 may identify the ability to contact another party identified from searching, accessing, and semantically processing the profiles of friends, associates, and corporate affiliates 404 through multiple levels of connection with the user as part of expanding their personal network or identifying a deficiency in their skill set from the user's profile information 403 when compared to other parties, which may have held the position in the past.

As depicted in the example illustrated in FIG. 4, the recommendations 407 may include recommendations for additional certifications, qualifications, and/or skills to improve a compatibility of the user with the possible job opportunity. For example, the system 200 may create a profile of the job and determine current or previous holders of the job or a similar job through online and/or social network information about people and their employment history. The system 200 may then identify from the information about the current or previous holders of the job or similar job one or more certifications, qualifications, and/or skills the holders had at the time of obtaining the job, received while holding the job, etc. and include such information in a profile of the job. The system 200 may then, based on, for example, a number of instances of common certifications, qualifications, and/or skills for holders of the job, a relevance or weighting of the certifications, qualifications, and/or skills, recommend one or more certifications, qualifications, and/or skills to the user for the user to obtain improve a compatibility of the user with the job and chances the user will be hired and/or successful with the particular job.

In these illustrative embodiments, the system 200 is described in the context of a search engine designed to assist a user to identify potential employment opportunities for which the user has a stated interest and for which the user may have one or more personal relationships that may allow the user to be recommended to the responsible hiring party associated with the opportunity. However, these descriptions are for the purpose of illustrating one example of the features of the present disclosure and are not intended as a limitation on the various embodiments that can be implemented in accordance with the principles of the present disclosure.

Embodiments of the present disclosure provide a system and method for receiving, processing, indexing, storing, and retrieving one or more ranked semantic search results in the personally identifiable information search domain (e.g., the job search domain).

This system may include an extensible crawling process that crawls numerous consumer, education, corporate, and employment information portals on the Internet and returns webpages corresponding to opportunities, product, and/or service offerings that are relevant to one or more information search domains. The crawling system and process may include one or more of the following: a repository of uniform resource locators (URLs) to numerous consumer and employer job portals that contain job listings; a segment batch generator that periodically generates a set of seed URLs that are checked for new job listings; a monitoring process that uses the output of the segment batch processor to check a set of consumer and employer job portals for the existence of new URLs that might correspond to job pages; a link database that manages the URLs identified by the monitoring process; another segment batch generator that retrieves a candidate set of URLs from the link database likely to correspond to job listings; a page fetcher that fetches the URLs returned by the segment batch generator; a page verifier that verifies the retrieved pages are complete and in a valid job listing format; a link manager that blacklists URLs that do not return complete pages in a valid job listing format; and a page repository that stores the retrieved pages for processing.

This system may further include a pre-processing engine that extracts the relevant text, data, and metadata from the webpages for semantic indexing. This pre-processing engine may include a parser forge that uses a page inspector to identify the page format type, selects an appropriate parser format, and instantiates a parser instance to parse the page; a page inspector that is capable of identifying a page structure out of a multitude of page structures using page structure definitions stored in a page structure repository; a page structure repository that stores definitions for a multitude of page structures; one or more parsers for parsing job page listings, which may use, as required, a taxonomy layer, zero or more ontologies, zero or more value mappers, zero or more alternate repositories for identifying the data and metadata components comprising the job page listings; a taxonomy layer that defines the data and metadata of interest; one or more ontologies that define the relationships between the data and metadata of interest; one or more mappers that use one or more normalization algorithms to map data and metadata to a common format (e.g., to standardize indexing); one or more alternate repositories that map fixed data and metadata items to standardized data and metadata elements (e.g., to standardize indexing); a text extraction component that extracts the raw text that comprises the webpage; a text block identification algorithm that identifies zero or more text blocks in the webpage corresponding to, for example, a company description, benefits (package) description, education and/or experience requirements, and core job description in the case that the webpage is a job listing; and a document categorizer that uses the extracted data and metadata to populate a set of standardized index fields that can be used to uniquely identify the webpage.

This system may further include an indexing component that uses one or more keyword, lemmatization, natural language processing, and/or other semantic processing technologies to generate semantically relevant metadata. The indexing component may include one or more natural language processing and/or semantic processing algorithms to extract relevant blocks of text for keyword, lemmatization, or other semantic indexing analysis; one or more keyword generators that can be used to generate statistically relevant keywords for identifying the webpage as potentially relevant with respect to a keyword query; one or more lemmatizers that can be used to generate statistically relevant topics referenced by the webpage for identifying the webpage as potentially relevant with respect to a semantic query; one or more duplication detector algorithms that can detect if blocks of text are repeated and are not to be reprocessed, or if the webpage is a duplicate of a previously-retrieved webpage (i.e., and is identified as such).

This system may further include a repository for storing the retrieved webpages; relevant text, data, and metadata; and the generated semantically relevant metadata.

This system may further include a generic social network manager for connecting to multiple social networks in which a user may be a member. The generic social network manager may include an authorization manager that allows a user to authorize use of one or more social networks and tracks the networks a user is authorized on; an access manager which controls a user's social network access with respect to the authorization granted by the user and the access limits imposed by the social network; a network manager that manages the social network profiles of the user, which may be accessed simultaneously; one or more platform adapters that handle the interface between the system and method described in this patent and the social network platform; and one or more language adapters that translate native system and method requests to platform requests for transmission through the platform adapters.

This system may further include a social network import engine, which is capable of retrieving the information associated with the user on those networks, their connections on the networks, and the information associated with their connections that they are authorized to access. The social network import engine may include a graph crawling component that is capable of retrieving the appropriate, authorized, accessible connection profiles and a schema mapping component, which translates the social network schema to the native system and method schema for manipulation by the native system.

This system may further include a social data normalization engine that is capable of processing and merging the retrieved data into a standardized normalized format that can be stored in a permanent or temporary repository. The social data normalization engine may include one or more mapper engines that use one or more normalization algorithms to map the profile and connection data and metadata to a common format; one or more alternate repositories that map fixed profile and connection data and metadata items to standardized data and metadata elements; a duplication detection component that is capable of merging duplicate data retrieved into a single data item; a social network tagging component that is capable of tagging what network(s) a piece of data was located on; and a persistence component that is capable of storing the retrieved profile data for the user and the user's connections in a temporary or permanent repository.

This system may further include one or more temporary or permanent social data repositories for storing a user's profile, connections, and related information.

This system may further include an input component, which is capable of accepting a user request or query, semantic or otherwise, processing that request or query, and formulating a well-formed semantic query. The input component may include an API that is capable of accepting requests, processing those requests for execution, retrieving the results from the processed requests, and returning the responses to the input medium used by the user, whether the medium used be a web browser on a desktop or laptop system, a customized mobile application on a mobile device, or a request through a customized application residing on a third party system.

This system may further include a semantic query engine, which is capable of accepting a well formed semantic query, running that query against the relevant data in the repositories that contain the documents of interest and the social repository, and returning a semantically relevant set of opportunity and products and social data. The semantic query engine may include a query translation component that translates the query into a standardized SPARQL (Simple Protocol and RDF (Resource Description Framework) Query Language) query for semantic processing; a semantic formatting component that is capable of loading the data and the semantic metadata stored in the job, resource, and social data repositories into standardized semantic tuples for a semantic query processor; and a semantic query processor that runs the standardized SPARQL query on the semantic tuples and returns the matching results.

This system may further include a ranking engine that receives the opportunity and product data and social data returned by the semantic query engine and ranks the data using one or more pre-programmed or custom ranking engines. The ranking engine may include a semantic data ranking sub-engine that ranks the results on semantic matches; a social data ranking sub-engine that ranks the results on social matches; and a ranking combiner sub-engine that combines the semantic data ranking output and the social data ranking output and combines them into a single, normalized ranking output.

This system may further include a presentation layer that takes the data and organizes the data for transmission to a user interface layer.

Additionally, this system may include a user interface layer that allows a user to register and log into the system, register and authorize one or more social networks on the system, define a search query with semantic and social components, present that query to the system for processing, view the ranked results of the query, retrieve the opportunity and product data and connection data associated with each result, and initiate relevant social search actions on the retrieved results including, but not limited to, watching for opportunities of a certain characteristic, accessing an opportunity or product, contacting a social connection associated with an opportunity or product, developing an extended network of connections associated with the opportunity or product to make contact with, retrieving additional information associated with the opportunity or product, and reporting third party information associated with the opportunity or product.

The user interface may include a social network management interface that allows a user to add one or more social networks, authorize access, and manage those networks; a query input mechanism that accepts a user query and sends the query to the semantic query engine; a display mechanism that displays the retrieved job listings and the social network associations; a display mechanism that displays the retrieved social network connections of relevance and the associated job listings; display mechanisms that display the companies associated with the retrieved job listings and the associated jobs and connections for each company; display mechanisms that display the locations associated with the retrieved job listings and the associated job listings and connections; a filter mechanism that allows the user to filter the jobs by relevant semantic and social components including, but not limited to, connection(s), company(ies), location(s), industry(ies), category(ies), (required or desired) skill(s), and/or educational requirement(s); a filter mechanism that allows the user to filter the connections by company, filtered jobs, and/or other measures and semantic components of relevance (possibly defined by number of jobs); a dynamic sorting mechanism that allows the job listings to be displayed by the combined data ranking, the social data ranking, the semantic data ranking, title order ascending, title order descending, recency descending, recency ascending, and zero or more other standard rankings that can be defined on job listings, connections, companies, locations, and/or other semantic and social components that can be searched, filtered, and ranked; a reach-out mechanism that allows the user to contact a social network connection and send them a request relating to one or more jobs or companies that are hiring that are located through the platform through e-mail, social network e-mail or messaging, and/or direct message with users currently on the system or a social network; a job management component that allows a user to watch and track job listings of interest; a “dream” job component that allows a user to define a job of interest and search for relevant jobs, connections, or potential (second and third degree) connections; a job search management component that allows a user to define, save, and refine searches of interest, re-run (or schedule to be re-run) those searches with a single command, and/or set up alerts against those searches to be alerted to new jobs or hiring companies that match the social semantic search profile; and a social network building component that allows a user to identify second, third, and higher degree connections on the user's authorized social networks that are relevant with respect to one or more saved or defined job search profiles.

FIG. 5 illustrates a block diagram of a semantic, job search, and aggregation system 500 in accordance with an illustrative embodiment of the present disclosure. In this illustrative embodiment, the system 500 may be implemented on one or more servers, such as the server 104 in FIG. 1. The system 500 is an open, semantic, job search and aggregation platform that includes three primary components; an aggregator 505 that can retrieve relevant job sites, a semantic search engine 510 that can return semantically relevant results that go beyond simple keyword matches, and a semantic ranking engine 515 that can calculate a job seeker's best match (and also a hiring manager's best candidates) using the candidate's profile, preferences, and available social network connections.

The system 500 allows a job seeker to transparently perform a semantic query across jobs from numerous sites across the Internet, including the major consumer and third party job sites and one or more major corporate recruitment portals (e.g., Taleo recruitment portal). The system 500 ranks the jobs relative to one or more of (1) the user's resume and preferences and (2) the user's social connections across multiple social networks, whether direct or indirect (1^{st}, 2^{nd} degree or beyond). For example, the social connections indicate relevance of the connections' ability to aid the job seeker in obtaining the job via direct association (e.g., they work in the hiring company) or indirect association (e.g., they know someone who works in the hiring company). In another example, the system 500 may rank the social connections based on a strength of the social connection (e.g., based on the amount of detected communication between the job seeker and the connection, the number of connections in common, and/or the strength of the computed or indicated relationship with the connection, etc.) to identify social connections that may be motivated to assist the job seeker or serve as a quality reference.

For hiring managers, the system 500 allows hiring managers to post jobs and not only semantically search public resumes on the system for the best candidates, but also to determine those candidates in the hiring manager's networks for whom the hiring manager can get referrals.

While the disruption of system 500 in FIG. 5 and/or other descriptions herein provide an example embodiment for semantic searching in for jobs, the discussion of the jobs search embodiment is intended as an example of the semantic search capabilities of the present disclosure and not intended as a limitation of the various embodiments that may be implemented in accordance with the present disclosure. For example, embodiments of the present disclosure may be implemented in any type of application where a social element can be combined with a semantic component which can, in turn, be applied and searched against online resources. For example, without limitation, additional embodiments include dating applications, education applications, mentorship applications, online community building applications, entertainment applications, book recommendation applications, etc. In one example, a specific set of results from the one the above (or other) applications are passed through the user's social connections for a personal and/or credible recommendation. One example of online dating includes, but is not limited to, a mechanism by which a user (e.g. the searcher of dates) views potential dating candidates and such candidates can be recommended by the user's social connections, or joint connections of both the user and potential dating candidates. Another example includes a movie recommendation based on reviews/recommendations by friends in their social profile.

FIG. 6 illustrates a block diagram of an example aggregator system 600 that may be used in the semantic, job search and aggregation platform illustrated in FIG. 5. In this illustrative embodiment, the aggregator 600 is a detailed example of one embodiment of aggregator 505 in FIG. 5.

The aggregator 600 includes a document fetcher 605 that fetches unstructured and semi-structured documents that contain job descriptions or related job resources, a structural formatter 610 that structures the retrieved pages, a component extractor 615 that identifies and extracts the relevant components, an ontological parser 620 that parses the extracted components for semantic elements, a semantic relation generator 625 that generates semantic relations, and a semantic indexer 630 that indexes the semantic relations in the semantic index.

The structural formatter 610 may include a modified HTML Parser that uses wrapper rules 611 and tokenization rules 612 to insure the document is properly structured (e.g., with proper closing tags) and free of superfluous tokens (e.g., for easier component identification and extraction). Many of the open-source Apache projects, including Lucene, Nutch, and Jackrabbit, contain HTML Parsers. The structural formatter 610 may include such a parser extended with appropriate wrapper generation rules and tokenization rules. The tokenization rules aid parsing by including rules that include, but are not limited to, the removal of display formatting tokens that are unnecessary for semantic data extraction and tokens that are empty.

The component extractor 615 may include generic and domain specific structured data templates 616 that allow the aggregator 600 to identify the parts of the semi-structured webpage produced by the structural formatter 610 that contains the relevant semantic information. The templates may include defined HTML page structures (e.g., including headers, footers, sidebars, and one or more content panes which include the content of interest) as organized, structured “pagelet” collections that allow the aggregator 600 to extract the components of interest.

The ontological parser 620 may be a supervised self-updating parser that utilizes existing ontologies and recognition rules, which may be automatically updated from trusted sources and approved users. The parser 620 may also use similarity rules to find ontology candidates when no ontological element can be identified, allowing for supervised learning when an approved user validates or invalidates a recommendation.

Once the ontological elements have been extracted, the semantic relation generator 625 generates semantic relations from semantic rule sets and represents them using a semantic mark-up language, which allows for semantic indexing and semantic searching. The semantic indexer 630 creates database friendly indexes for fast search and retrieval on recognized semantic queries using appropriate normalization techniques.

The semantic search engine 510 receives semantic inputs based on user inputs, user profiles, and social network profiles and structures a semantic query on the indices created by the semantic indexer 630. The semantic search engine 510 then returns those records that match the query for ranking by the semantic ranking engine 515.

The semantic ranking engine 515 receives a semantic query, a preferences profile, the user's social network information and connections, and the results of a semantic search. The semantic ranking engine 515 then performs one or more rankings on the results in order of best match for the particular user using one or more generic and/or proprietary ranking algorithms.

FIG. 7 illustrates a block diagram of another example aggregator system 700 that may be used in the semantic, job search, and aggregation platform illustrated in FIG. 5. In this illustrative embodiment, the aggregator 700 is a detailed example of another embodiment of aggregator 505 in FIG. 5.

The aggregator 700 fetches relatively unstructured and semi-structured documents that contain job descriptions, company descriptions, and descriptions of related job resources from the Internet 202, structures the retrieved pages for component pagelet identification, identifies and extracts the pagelet components that contain elements of the description, parses for semantic elements using the ontological parser, generates semantic relations, and then indexes those relations in a semantic index that enables quick results/solutions for a semantic query (e.g., in some embodiments in under three seconds). The aggregator 700 includes master/slave crawler nodes 705 that fetch the webpages in segment files 706 given a collection of URLs.

Parse manager 710 analyzes the segment files returned by the crawler nodes 705 and breaks out individual pages/documents 711. Document analyzer 715 analyzes the documents 711 and partitions the pages into job-related and non-job-related pages. Job page inspector 720 analyzes job-related pages and partitions the job-related pages into pages with an identifiable, parseable structure and pages without an identifiable structure 721, which may be manually reviewed, processed, and entered into the system 500. Parser forge 725 routes the job-related pages with identifiable structure to an appropriate parser instance 726. The parser instances 726 parse the pages to generate semi-structured job, company, and other resource descriptions 727 from the pages and may be specifically created to systematically parse webpages for particular job and job-related websites.

Data pipeline 730 takes the semi-structured job description 727 output by a parser 726 and breaks the description 727 into individual semantic elements 731. Ontological parser 735, which may be supervised and/or self-updating, such as the parser 620 in FIG. 6, uses ontologies and natural language parsing to identify those ontological elements 736 that are relevant for semantic indexing.

The semantic relation generator 740 generates semantic relationships 741 between the ontological elements that have been identified. Semantic indexer 745 indexes the generated semantic relationships 741 and stores semantic job descriptions 746 (e.g., in a repository 310) for rapid search and retrieval.

FIG. 8 illustrates a block diagram of a semantic, job search, and aggregation system 800 implemented with a mobile platform and recommendation engine in accordance with an illustrative embodiment of the present disclosure. In this illustrative embodiment, the system 800 may be an example of the system 500 in FIG. 5 implemented with additional components, such as a mobile platform and recommendation engine. The system 800 may be implemented on one or more servers, such as the server 104 in FIG. 1.

In this illustrative embodiment, the system 800 provides, in addition to system 500, a semantic information reporting engine 805 to identify and provide relevant resources related to a job in question from multiple data sources; a mobile interface 810 to allow jobseekers to access their job search platform from their mobile devices on the go, a recommendation engine 815 to recommend appropriate books, courses, new connections, and supporting job search resources; a workflow management engine 820 with an intelligent workflow and integrated business process management to provide value to hiring managers and entice hiring managers to list jobs natively; and a semantic information reporting engine 805 that can be used to output reports to external users related to one or more user initiated queries.

The semantic information reporting engine 805 provides aggregation and integration of information related to a job and an employer from third party information sources. Once a job seeker has identified a potential job, the next thing the job seeker wants to do is find out all they can about the job and the company. Most of this information is often on other websites that include, but are not limited to, the corporate website, news websites, financial websites, and user communities. The semantic information reporting engine 805 utilizes the aggregator 505 to recognize, parse, and extract information from these information websites as well.

The semantic information reporting engine 805 utilizes the aggregator 505 to identify and parse relevant information beyond job descriptions. For example, the aggregator 505 includes a baseline extension that parses major financial sites (e.g., Bloomberg, Yahoo! Finance, and Hoovers websites), news sites (e.g., CNN, BBC News, and TechCrunch websites), and user communities (e.g., Ning, Job Forum Canada, and LinkedIn's Job Forums websites) that are based on standard forum, wild, and blog packages. The aggregator 505 provides the parsed company information 806 to a reporting engine 807 that organizes and provides information about companies and their jobs in response to user or hiring manager queries and searches.

The mobile interface 810 includes a mobile API architecture that supports adapters for each of the supported mobile platforms (which may include, but not be limited to, Android, iOS, Blackberry OS, and Windows Mobile or a mHTML (mobile HTML) compatible browser) for presentation and delivery to user's mobile devices, for example, via mobile browsers and/or applications. The mobile interface 810 includes a mobile translation interface 811 that converts and/or translates the information from the system 800 into a mobile device operating system-friendly format and vice versa. The mobile interface 810 also includes a mobile display interface 812 that displays information received from the system 800 and receives inputs from a user in a mobile device friendly format.

The recommendation engine 815 provides capabilities of the semantic ranking engine to support the identification of the relevant books, courses, and other resources for a job seeker based on where they are in their career and the job that they want to get. The recommendation engine 815 matches a job seeker with the resources they may need to advance their career. Based on a job seeker's resume, career goals, and extracted qualifications of persons having a career matching the job seeker's career goals, the recommendation engine 815 identifies relevant materials including, but not limited to, skills, books, courses, degrees, new contacts, and professional job search resources that could help the job seeker and put the job seeker on a path to obtaining the job seeker's career goals.

For example, if a job seeker is a Java Architect, the recommendation engine 815 may recommend books on advanced enterprise architecture in Java instead of introductions to Java programming In another example, if a job seeker is looking to stay technically focused and has a Bachelor's of Computer Science degree, then the recommendation engine 815 may recommend technically focused Master's degree programs, such as a Masters of Computer Science or Masters of Science instead of Executive Masters of Business Administration. In another example, if the job seeker's resume or profile information indicates weak communication skills or writing skills, then the recommendation engine 815 may provide recommendations of appropriate services that can help the job seeker with her resume and communication skills. In another example, the recommendation engine 815 may identify and suggest new connections for a user to connect with on a social network. For example, if a user is interested in a particular job, the recommendation engine 815 may suggest second or third degree social network connections to connect to, as well as first degree connections in common to facilitate such connections. In another example, the recommendation engine 815 may, based on a user's desired job or career path, identify a set of common qualifications of persons having the user's desired job or future career that are missing from the user's resume or qualifications. In this example, the recommendation engine 815 may then provide recommendations of degrees, books, classes, services, and/or connections that enable the user to attain those qualifications to increase a user's chances of obtaining the desired job or career path.

The recommendation engine 815 includes an extension to the ranking engine 515 that provides recommendations of books, online training materials and courses, degree programs, and other items of interest that are relevant with respect to a user's current career path. The recommendation engine 815 includes interfaces to integrate with the major book retailers (e.g., Amazon, Barnes and Nobel, and Indigo book retailers), university and career portals (such as the AUCC Directory of Canadian Universities, 50States.com, and The Open University), and matches submitted descriptions of training materials, courses, and degree programs with a user's needs to provide specific recommendations.

The recommendation engine 815 may also provide resume assistance services, time management, and communication and presentation skills that could be of assistance to the job seeker. For example, the recommendation engine 815 may identify appropriate introductory books, courses, and services for a job seeker looking to change the trajectory of her career path based upon the job seeker's current education and experience. For example, an engineer looking to move into management would be presented options for project management, finance, or information technology MBAs—depending on what was the next logical step on their career path—as opposed to generalized or Executive MBAs. In another example, a mechanical engineer looking to get into software development would be presented with courses and degree programs focused entirely on software and not on four-year BScs, as the individual would already have an equivalent degree.

The workflow management engine 820 with intelligent workflow and integrated business process management assists hiring managers and job seekers in the job creation and job management processes. The workflow management engine 820 provides job seekers the ability to apply for jobs and hiring managers the ability to post jobs, provides job seekers and hiring managers the ability to manage the job application or creation process, and includes a business-process driven workflow that guides job seekers and hiring managers through this process. The workflow management engine 820 is “intelligent” enough to not only allow a hiring manager to manage the entire job search process, but also to guide the hiring manager through that process.

For example, when a hiring manager wants to create a new job, the workflow management engine 820 not only allows the hiring manager to start with templates or similar job descriptions, but includes questions that, when answered, may assist the hiring manager to determine listing and promotion strategies, identify qualified individuals in the hiring manager's social network(s) for applications and referrals, alert the manager as to when to do phone interviews and what information to record, assist the manager in getting input from other stakeholders into the system, generate weighted recommendations for hiring, and track the documentation needed. The workflow management engine 820 can also perform similar applicable tasks for a job seeker.

In various embodiments, the system 800 provides semantic social network integration. For example, system 800 includes an adapter layer that allows for native social network applications which allow the user to access the job search platform from a third party social network.

In various embodiments, the system 800 provides automatic semantic query formulations. For example, the system 800 can allow a job seeker or a hiring manager to do a “like” query given a job description or a resume. A job seeker may see a job posting and think that the type of job would be perfect and wish to find more similar jobs. A hiring manager may see an applicant and think that their resume is that of a great candidate and would like to find more similar resumes. In these examples, the system 800 allows job seekers and hiring managers to get great results upon specifying the correct semantic query. For example, knowing what they want, users may provide or identify a sample of what the user wants and specify that they “like” that sample. Upon receiving such a sample, the system 800 can automatically extract and formulate a query saving users time.

In various embodiments, system 800 provides data mining and trend detection capabilities. The system 800 uses the data compiled to leverage and identify trends for job seekers and hiring managers. For example, the system 800 can identify where the job market is headed, what industries are seeing the most growth and posting the most jobs, what jobs are getting the most and least applicants, and what job seeking strategies are likely to be the most appropriate for the job seeker. Similarly, the system 800 can identify what types of jobs are of most interest to job seekers, what careers job seekers are migrating to, in what industries and/or job categories there is a shortage of qualified applicants, and how that is expected to trend over time for hiring managers. This information could be presented to the user or the hiring manager through the reporting engine 807.

FIG. 9 illustrates a block diagram of a multi-lingual parser framework system 900 in accordance with an illustrative embodiment of the present disclosure. In this illustrative embodiment, the multi-lingual parser framework system 900 provides multilingual support to process and provide job-related information in multiple languages. For example, the system 900 may be an example of one embodiment of the aggregator system 700 including multilingual support.

Primary multilingual components within the system 900 include a linguistic document classifier 905 to determine the language of a document, a document analyzer forge 910 that instantiates linguistic document analyzer modules 915 specific to each language, and a resource inspector forge 920 that can instantiate language-specific resource inspectors to determine if a page is, in fact, a job description, resume, news article, book summary, or other page of interest.

One of the first steps performed by the system 900 is the identification of which language(s) are being dealt with. The linguistic document classifier 905 uses web-page structural identifiers 906 to identify and display text, and language identifier rules 907 for each language supported. The linguistic document classifier 905 accurately identifies the language of the page as linguistically tagged pages 908 for each language supported or identifies the language as a language not supported.

Once the language is identified, the document analyzer forge 910 determines how to parse the page. For example, the document analyzer forge 910 identifies and parses the metadata associated with the page to determine the likely classification of the page (e.g., into a job post, a resume, a news article, a book summary, a spam posting, or another category). Once the classification of the page is verified with additional classification rules, the document analyzer forge 910 parses the page to extract the relevant data. To identify the metadata, the document analyzer forge 910 includes document analyzers specific to each language that are, in turn, supported by language-specific metadata identification rules to generate linguistic metadata identifiers 916 for the page. The document analyzer forge 910 includes a rules base, such that, given a page, a linguistic identifier for the page, and any other relevant output from the document classifier 905, the document analyzer forge 910 instantiates an appropriate document analyzer (e.g., as there may be more than one for a language since, some languages need different rules for each dialect or each type of speech, such as informal, formal, technical, etc.).

To parse the page, the resource inspector forge 920 loads an appropriate language-specific, resource-specific parser that knows what to look for in the page and how to extract the relevant data. The resource inspector forge 920 accurately identifies the page type, and strips out any superfluous text and elements (e.g., that may exist in the header, footer, or sidebars). The resource inspector forge 920 then, given the metadata output by the document analyzer forge 910 and the language specific metadata identifiers, loads an appropriate resource inspector 921 to accurately identify and format the pages for storage in a staging repository, where the pages are then processed by an appropriate parser 922.

In various embodiments, the system 900 includes different rules, classifiers, analyzers, and parsers for each language. At a high level, each language has its own phonologic, morphologic, lexical, syntactic, semantic, discourse, and cultural ambiguities that may not match up language to language. A term with one meaning in one language might have two meanings in another language and no meaning in a third language or may overlap with a term used in the ontological classification of the concept and blur the line between concept and instance. In other words, one does not always have the case of translation equivalents, transfer rules for syntactic structures, or well-defined semantic classes when trying to map semantic rules from one language to another.

Other problems include mixed letters, such as the “ae” from Latin, diacritics (which is common in languages like French and Polish and which, in Arabic languages, can completely change the sentence meaning, structure, and voice), different levels of plurality (such as one or many; one, two, or many; one, two, three, or many), gender/plurality-specific verb tenses (such as “avoir” in French), gender/subject-specific affix changes (such as changing names in Polish depending on whether the person is the subject or object or a man or a woman), cultural expressions and metaphors (for example, just because a job calls for someone who has experience “putting out fires” does not mean the job is for a firefighter), and styles of speaking (as the Japanese, for example, have at least 15 different ways to say “I” depending on the formality, humbleness, and class dictated by the situation). The multi-lingual parser framework system 900 includes the ability to customize each and every step of the process for each language supported

FIG. 10 illustrates a block diagram of one example of a keyword generation and annotation framework system 1000 in accordance with an illustrative embodiment of the present disclosure. In this illustrative embodiment, the system 1000 may be implemented on one or more servers, such as the server 104 in FIG. 1. As depicted, the keyword generation and annotation framework system 1000 includes a keyword analyzer 1005, a keyword analyzer forge 1010, a lemmatizer forge 1015, and an annotator forge 1020.

The keyword analyzer forge 1010 receives a document with language 1011 and metadata identifiers 1012. Upon receipt, the keyword analyzer forge 1010 identifies appropriate keyword analyzer 1005 for the document. The keyword analyzer forge 1010 then identifies the appropriate stop word lists 1006, selection rules 1007, and parsing rules to identify which parts of the text keywords are selected from.

The lemmatizer forge 1015 receives a set of keywords 1016 from the keyword analyzer forge 1010 along with a language identifier, context, and source text for those keywords. The lemmatizer forge 1015 identifies the proper lemmatizer 1017 for the language and context. Depending on the language, the lemmatizer 1017 could be rule-based, statistical natural language processing (NLP), or a hybrid thereof. Whereas a stemmer may only need suffix rules, the lemmatizer 1017 uses suffix rules for the language, as well as tense, gender, plurality, and context rules to properly identify a lemma and generate lemmatized keywords 1018.

The annotator forge 1020, like the keyword 1010 and lemmatizer 1015 forges, identifies an appropriate annotator 1021 for each language. The language specific annotators 1021 for each language take into account the phonologic, morphologic, lexical, syntactic, semantic, discourse, and cultural ambiguities that exist between languages and the specific diacritic, plurality, gender, and tense rules that exist in each language. While many statistical NLP algorithms are pseudo-language independent and can often be modified and trained on other languages, and while some lemmatization rules are similar for languages in the same class of languages (e.g., Western Germanic, Baltic, and Ugric) that use the same alphabets (e.g., Latin, Cyrillic, and Arabic), the differences between languages, and the cultural use of such language, is such that there is no true language independence. To deal with the fact that current lemmatization techniques are not language independent, the system 1000 uses language specific annotators 1021 for each language. The system 1000 identifies the plurality, tense, and affix rules from the chosen lemmatizer(s) and supports multi-language keyword and annotation generation to provide results for job postings in multiple languages.

FIG. 11 illustrates a block diagram of an example heuristic query processing system 1100 in accordance with an illustrative embodiment of the present disclosure. The heuristic query processing system 1100 is an example of one embodiment of processing a query received from a user, such as in step 401 of FIG. 4, for example. In this illustrative embodiment, the system 1100 may be implemented on one or more servers, such as the server 104 in FIG. 1. Heuristic query processing system 1100 is an example of heuristic query processing in a jobs and connections related embodiment. Other types of heuristic query processing system(s) may be implemented in accordance with the principles of the present disclosure.

When a query 1101 is received, the heuristic query processing system 1100 processes the query 1101 using a query annotator 1105 that extracts relevant key words and key query identifiers to retrieve potentially relevant jobs from a jobs database 1106 (e.g., jobs that are not in the set of jobs known to be not relevant) and retrieve connection profiles of the user who initiated the query 1101 from a connections database 1107. The heuristic query processing system 1100 also includes a query optimizer 1110, which is backed up by a statistical profiler 1115, a semantic profiler 1120, a query strategy selector 1125, and a heuristic rewriter component 1130. The heuristic query processing system 1100 uses these components to determine, in real-time, the near-optimal query strategy to reduce the number of tuples fed into a semantic query engine 1135.

For example, consider a user looking for a Java™ software developer job who only wants to see jobs for which the user has the required skills. In this example, perhaps 60% of the 2,500 Java™ software developer jobs in the database 1106 at the point in time the user submits the query require Unified Modeling Language™ modeling experience that the user does not have. In this example, loading all 2,500 Java™ software development jobs into the semantic query engine 1135 may waste time, since the user may not qualify for 1,500 of them. In this example, query optimizer 1110 can filter out all jobs that require Unified Modeling Language™ modeling experience to reduce the job search space by 60%. In another example, if a user was only interested in jobs for which he had a first degree connection to the company, the semantic query engine 1135 can only load those jobs where the user had a first degree connection to the company, which saves processing time. In another example, if a user asked for a Java™ software developer job in Dallas, Tex. that was not in the IT industry, the semantic profiler 1120, upon realizing that such a search space was sparse, invokes the heuristic rewriter component 1130 to rewrite the initial query to be for Java™ software developer jobs in Dallas, Tex. in engineering or finance, as those were the only other industries in which Java™ software developer jobs exist. Thus, the heuristic rewriter component 1130 attempts to rewrite the query in such a way that permits the query to be executed quickly without sacrificing soundness or completeness. For example, the heuristic rewriter component 1130 attempts to rewrite the query in such a way that permits the query to be executed quickly without providing false results or missing results. The query optimizer 1110 may also detect if the user accidentally asked for an empty query, for example, a developer job in IT for someone without computer skills and all developer jobs in the jobs database required computer skills. In this example, the query optimizer 1110 may determine that user meant to ask for a developer job in IT for someone with computer skills and suggest the reformulation.

In this illustrative embodiment, the query annotator 1105 sends multiple cardinality queries to the databases 1106 and 1107 to determine how many records are associated (and thus not associated) with each query parameter and how many connections are associated with the user and other relevant parameters (such as company, industry, etc.). The query annotator 1105 sends this information to the query optimizer 1110. The query optimizer 1110 runs some or all of the information available to it through the statistical 1115 and semantic 1120 profilers to determine optimization suggestions. The query optimizer 1110 sends the optimization suggestions to the query strategy selector 1125 to determine an optimized and/or improved execution strategy. The query optimizer 1110 sends the strategy and the query to the heuristic rewriter 1130 to formulate the optimized and/or improved query to retrieve the minimum and/or reduced set of job and connection record tuples. The query optimizer 1110 sends the appropriate tuples to the semantic query engine 1135.

In various embodiments, the semantic query engine 1135 receives the data, pushes it into a semantic web framework (e.g., the JENA semantic web framework) and uses a query language (e.g., SPARQL) to identify semantically relevant jobs, and when possible, semantically relevant connections to those jobs and outputs (user, job, null) tuples for each semantically relevant job and (user, job, connection) tuples for each semantically relevant job with a connection. The semantic query engine 1135 sends the tuples output to a ranking engine 1140, which ranks each tuple, for example, based on semantic relevance, connection relevance, and/or a hybrid relevance measure.

FIG. 12 illustrates an example of a user interface 1200 for displaying job search results to a user in accordance with an illustrative embodiment of the present disclosure. In this illustrative example, the user interface 1200 is one example of results for a job search that can be displayed to a user upon completion of a search. For example, the user interface 1200 may be displayed on a client device, such as client devices 106-114 in FIG. 1, and may display results and recommendations based on processes for extracting semantic information from various data sources utilizing a semantic framework, for example, as illustrated in FIG. 4.

The user interface 1200 includes a list of job search results 1205 that include information about the job position, the company, and the number of connections of the user that are listed as associated with the company (through current employment, past employment, or a relationship with a current or past employee), and therefore, may be able to help the job seeker with a referral or information about the job. In this particular example, a search query of sales in Dallas, Tex. was input, and 2,500 results were identified. The results 1205 displayed may be ranked based on the number of social network connections of the user that are listed as associated with the company, query keyword relevance, most recent postings, etc. The user interface 1200 also provides information about opportunities associated with a user's connections. For example, selection of connections tab 1210 displays social network connections and the jobs that are associated with the user's social network connections. Selection of companies tab 1215 or cities tab 1220 displays numbers and information about jobs associated with particular companies or cities.

The user interface 1200 also provides intuitive filtering of the results 1205. For example, selection of a particular connection from drop-down connections in the connections filter 1225 filters the results to those for which a particular connection may be able to help the job seeker with a referral. Additionally, selection for filtering based on company, location, industry, and/or education may result in those for a particular company, location, industry, and/or education, respectively.

FIG. 13 illustrates an example of a user interface 1300 for sending a message to a social network connection for assistance in a job search in accordance with an illustrative embodiment of the present disclosure. In this illustrative example, the user interface 1300 is one example of a message that may be automatically generated, for example, by selection of a “reach out” option 1230 in the user interface 1200 in FIG. 12. As illustrated, the user interface 1300 generates and displays a template message to be sent to a connection associated with a job listing. In this manner, job seekers are provided with tools to reach out to connections for assistance and information on interested jobs.

The flowchart and block diagrams in the figures illustrate the architecture, functionality, and operation of various possible implementations of systems, methods, and computer program products according to various illustrative embodiments. In this regard, each block in the flowchart or block diagrams may represent a module, segment, function, and/or a portion of an operation or step. For example, one or more of the blocks may be implemented as program code, in hardware, or in an NMR (Nuclear Magnetic Resonance) quantum computer that uses molecules (of alanine, for e.g.) in a strong, static magnetic field, or a combination of the program code, hardware, or an implementation of an NMR quantum computer. When implemented in hardware, the hardware may, for example, take the form of integrated circuits that are manufactured or configured to perform one or more operations in the flowcharts or block diagram.

In some embodiments, the function or functions noted in the block may occur out of the order noted in the figures. For example, in some cases, two blocks shown in succession may operate substantially concurrently, or the blocks may sometimes be executed in the reverse order, depending upon the functionality involved and the output of the query optimizer, for example. Also, other blocks may be added in addition to the illustrated blocks in a flowchart or block diagrams.

FIG. 14 illustrates a block diagram of a computing device 1400, which may be utilized to implement various embodiments of the present disclosure. In this example, the computing device 1400 includes a bus system 1402, which supports communication between a processing unit 1404, a memory 1406, a persistent storage 1408, a communications unit 1410, an input/output (I/O) unit 1412, and a display 1414. In these illustrative examples, computing device 1400 is an example of one implementation of server 104 and client devices 106-114 in FIG. 1.

The processing unit 1404 executes instructions that may be loaded into a memory 1406. The processing unit 1404 may include any suitable number(s) and type(s) of processing units or other devices in any suitable arrangement. Example types of processing unit 1404 include microprocessors, microcontrollers, digital signal processors, field programmable gate arrays, application specific integrated circuits, discrete circuitry, and qubits (in a NMR quantum computing machine).

Memory 1406 and persistent storage 1408 are examples of storage device 1416, which represent any structure(s) capable of storing and facilitating retrieval of information (such as data, program code, and/or other suitable information on a temporary or permanent basis). The memory 1406 may represent a random access memory or any other suitable volatile or non-voltile storage device(s). The persistent storage 1408 may include one or more components or devices supporting longer-term storage of data, such as a read-only memory, magnetic tape, hard drive, RAM (Random Access Memory), DRAM (Dynamic Random Access Memory), MRAM (Magneto-resistive Random Access Memory), T-RAM (thyristor RAM), flash memory (including PROM, EPROM, and EEPROM), qubits (in a stable magnetic field), or optical disc (such as CD, DVD, or BluRay).

Communication unit 1410 provides for communications with other data processing systems or devices. In these examples, communication unit 1410 may include a wireless (cellular, WiFi, WiMAX, Bluetooth, etc.) transmitter, receiver and/or transmitter, a network interface card, and/or any other suitable hardware for sending and/or receiving communications over a physical or wireless communications medium. Communication unit 1410 may provide communications through the use of either or both physical and wireless communications links.

Input/output unit 1412 allows for input and output of data with other devices that may be connected to computing device 1400. For example, input/output unit 1412 may provide a connection for user input through a keyboard, a mouse, a tablet, an appropriately configured monowheel “IT”, and/or some other suitable input device. Further, input/output unit 1412 may send output to a printer.

Input/output unit 1412 allows for input and output of data with other devices that may be connected to or a part of the electronic device 1400. For example, input/output unit 1412 may provide a connection for user input through a keyboard, a mouse, an external microphone, and/or some other suitable input/output device. In some embodiments, input/output unit 1412 may include a touch panel to receive touch user inputs, a microphone to receive audio inputs, a speaker to provide audio outputs, and/or a motor to provide haptic outputs. Further, input/output unit 1412 may send output to a printer.

Display 1414 provides a mechanism to display information to a user. In some embodiments, the display 1414 may be a touch screen implemented in connection with the input/output unit 1412. In other embodiments, the display 1414 may be external to the computing device 1400 and connectable via a cable or over a network connection, for example.

Program code for an operating system, applications, or other programs may be located in storage device 1416, which is in communication with the processing unit 1404 through the bus system 1402. In some embodiments, the program code is in a functional form on the persistent storage 1408. These instructions may be loaded into memory 1406 for processing by processing unit 1404. The processes of the different embodiments may be performed by processing unit 1404 using computer-implemented instructions, which may be located in memory 1406. For example, processing unit 1404 may perform processes for one or more of the modules and/or devices described above.

In some embodiments, various functions described above are implemented or supported by a computer program product that is formed from computer-readable program code and that is embodied in a computer-readable medium. Program code for the computer program product may be located in a functional form on a computer-readable storage device that is selectively removable and may be loaded onto or transferred to computing device 1400 for processing by processing unit 1404. In some illustrative embodiments, the program code may be downloaded over a network to persistent storage 1408 from another device or data processing system for use within computing device 1400. For instance, program code stored in a computer-readable storage medium in a server computing device may be downloaded over a network from the server to computing device 1400. The computing device providing program code may be a server computer, a client computer, or some other device capable of storing and transmitting program code.

As will be appreciated by one skilled in the art, aspects of the present disclosure may take the form of a computer program product embodied in one or more computer-readable storage medium(s) having program code embodied thereon. A computer-readable storage medium may be, for example, without limitation, a portable computer diskette, a hard disk, a random access memory (RAM) or derivations thereof, a read-only memory (ROM) or derivations thereof, an erasable programmable read-only memory (EPROM or Flash memory), a portable compact disc read-only memory (CD-ROM), an optical storage device, a magnetic storage device, a collection of qubits, or any suitable combination of the foregoing. The program code may also be loaded for execution by a processing unit to provide processes for implementing the functions or operations described in the present disclosure.

It may be advantageous to set forth definitions of certain words and phrases used throughout this patent document, The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following: A, B, and C; A and B; A and C; B and C; A; B; and C.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for searching for employment opportunities, the method comprising:
searching a plurality of webpages on a plurality of websites for the employment opportunities;
processing the webpages to determine information about the employment opportunities including at least an employer for each of the employment opportunities;
identifying social network connections of a user;
searching information from one or more social network websites to identify at least one of a current or previous employer of one or more of the social network connections of the user; and
in response to receiving a query from a user, returning a list of potential employment opportunities including information about one or more of the social network connections of the user identified as currently or previously employed or associated with a current or previous employee of an employer of one or more of the potential employment opportunities.

2. The method of claim 1 further comprising:
identifying information about a skill set of the user from one or more social network webpages associated with the user; and
ranking the potential employment opportunities in the list based on the social network connections of the user and the information identified about the skill set of the user compared with information about a skill set desired or required for one or more of the potential employment opportunities;
wherein the information about the employment opportunities determined by processing of the webpages further includes information about the desired or required skill set for one or more of the potential employment opportunities.

3. The method of claim 1 further comprising:
identifying at least one of (i) one or more potential social network connections to connect with or (ii) skills or qualifications for the user to obtain to improve a compatibility between the user and one or more of the potential employment opportunities; and
providing recommendations on at least one of (i) the one or more potential social network connections to connect with or (ii) the skills or qualifications for the user to obtain.

4. The method of claim 1, wherein searching the webpages for the employment opportunities comprises:
crawling information portals on the Internet and returning the webpages that are relevant to the employment opportunities;
storing uniform resource locators (URLs) for the webpages; and
periodically generating a set of seed URLs, which are retrieved or derived from the stored URLs, to be checked for listings of the employment opportunities.

5. The method of claim 1, wherein processing the webpages to determine the information about the employment opportunities comprises:
extracting information including text, data, and metadata from the webpages for semantic indexing; and
indexing the extracted information using one or more of keyword, lemmatization, or natural language processing to generate semantically relevant metadata.

6. The method of claim 5, wherein extracting the information from the webpages comprises:
identifying a page format type of at least one of the webpages;
identifying a page structure of the at least one webpage using page structure definitions stored in a page structure repository;
parsing the at least one webpage based on the identified type and the identified page structure;
identifying one or more text blocks in the at least one webpage that correspond to a descriptive element of interest; and
storing metadata for the at least one webpage that includes information about the descriptive element of interest.

7. The method of claim 5, wherein indexing the extracted information comprises:
generating keywords for identifying a parsed webpage as potentially relevant with respect to a keyword query;
generating topics referenced by the parsed webpage for identifying the parsed webpage as potentially relevant with respect to a semantic query; and
determining whether information in the parsed webpage is duplicative of information in a previously retrieved webpage.

8. A system for searching for employment opportunities, the system comprising:
a storage device configured to store program code;
a communication unit; and
a processing unit configured to execute the program code to:
search, via the communication unit, a plurality of webpages on a plurality of websites for the employment opportunities;
process the webpages to determine information about the employment opportunities including at least an employer for each of the employment opportunities;
identify social network connections of a user;
search, via the communication unit, information from one or more social network websites to identify at least one of a current or previous an employer of one or more of the social network connections of the user; and
in response to receiving a query from a user, return, via the communication unit, a list of potential employment opportunities including information about one or more of the social network connections of the user identified as employed currently or previously employed or associated with a current or previous employee of an employer of one or more of the potential employment opportunities.

9. The system of claim 8, wherein the processor is further configured to execute the program code to:
identify information about a skill set of the user from one or more social network webpages associated with the user; and
rank the potential employment opportunities in the list based on the social network connections of the user and the information identified about the skill set of the user compared with information about a skill set desired or required for one or more of the potential employment opportunities;
wherein the information about the employment opportunities determined by processing of the webpages further includes information about the desired or required skill set for one or more of the potential employment opportunities.

10. The system of claim 8, wherein the processor is further configured to execute the program code to:
identify at least one of (i) one or more potential social network connections to connect with or (ii) skills or qualifications for the user to obtain to improve a compatibility between the user and one or more of the potential employment opportunities; and
provide, via the communication unit, recommendations on at least one of (i) the one or more potential social network connections to connect with or the (ii) skills or qualifications for the user to obtain.

11. The system of claim 8, wherein in searching, via the communication unit, the webpages for the employment opportunities, the processor is further configured to execute the program code to:
crawl, via the communication unit, information portals on the Internet and return the webpages that are relevant to the employment opportunities;
store, in the storage device, uniform resource locators (URLs) for the webpages; and
periodically generate a set of seed URLs, which are retrieved or derived from the stored URLs, to be checked for listings of the employment opportunities.

12. The system of claim 8, wherein in processing the webpages to determine the information about the employment opportunities, the processor is further configured to execute the program code to:
extract information including text, data, and metadata from the webpages for semantic indexing; and
index the extracted information using one or more of keyword, lemmatization, or natural language processing to generate semantically relevant metadata.

13. The system of claim 12, wherein in extracting the information from the webpages, the processor is further configured to execute the program code to:
identify a page format type of at least one of the webpages;
identify a page structure of the at least one webpage using page structure definitions stored in a page structure repository;
parse the at least one webpage based on the identified type and the identified page structure;
identify one or more text blocks in the at least one webpage that correspond to a descriptive element of interest; and
storing, in the storage unit, metadata for the at least one webpage that includes information about the descriptive element of interest.

14. The system of claim 12, wherein in indexing the extracted information, the processor is further configured to execute the program code to:
generate keywords for identifying a parsed webpage as potentially relevant with respect to a keyword query;
generate topics referenced by the parsed webpage for identifying the parsed webpage as potentially relevant with respect to a semantic query; and
determine whether information in the parsed webpage is duplicative of information in a previously retrieved webpage.

15. A non-transitorily computer readable medium comprising program code for searching for employment opportunities, the computer readable medium comprising program code for:
searching a plurality of webpages on a plurality of websites for the employment opportunities;
processing the webpages to determine information about the employment opportunities including an employer for each of the employment opportunities;
identifying social network connections of a user;
searching information from one or more social network websites to identify at least one of a current or previous employer of one or more of the social network connections of the user; and
in response to receiving a query from a user, returning a list of potential employment opportunities including information about one or more of the social network connections of the user identified as currently or previously employed or associated with a current or previous employee of an employer of one or more of the potential employment opportunities.

16. The computer readable medium of claim 15 further comprising program code for:
identifying information about a skill set of the user from one or more social network webpages associated with the user; and
ranking the potential employment opportunities in the list based on the social network connections of the user and the information identified about the skill set of the user compared with information about a skill set desired or required for one or more of the potential employment opportunities;
wherein the information about the employment opportunities determined by processing of the webpages further includes information about the desired or required skill set for one or more of the potential employment opportunities.

17. The computer readable medium of claim 15 further comprising program code for:
identifying at least one of (i) one or more potential social network connections to connect with or (ii) skills or qualifications for the user to obtain to improve a compatibility between the user and one or more of the potential employment opportunities; and
providing recommendations on at least one of (i) the one or more potential social network connections to connect with or (ii) the skills or qualifications for the user to obtain.

18. The computer readable medium of claim 15, wherein the program code for searching the webpages for the employment opportunities comprises program code for:
crawling information portals on the Internet and returning the webpages that are relevant to the employment opportunities;
storing uniform resource locators (URLs) for the webpages; and
periodically generating a set of seed URLs, which are retrieved or derived from the stored URLs, to be checked for listings of the employment opportunities.

19. The computer readable medium of claim 15, wherein the program code for processing the webpages to determine the information about the employment opportunities comprises program code for:
extracting information including text, data, and metadata from the webpages for semantic indexing;
identifying a page format type of at least one of the webpages;
identifying a page structure of the at least one webpage using page structure definitions stored in a page structure repository;
parsing the at least one webpage based on the identified type and the identified page structure;
identifying one or more text blocks in the at least one webpage that correspond to a descriptive element of interest; and
storing metadata for the at least one webpage that includes information about the descriptive element of interest.

20. The computer readable medium of claim 15, wherein the program code for processing the webpages to determine the information about the employment opportunities comprises program code for:
indexing the extracted information using one or more of keyword, lemmatization, or natural language processing to generate semantically relevant metadata;
generating keywords for identifying a parsed webpage as potentially relevant with respect to a keyword query;
generating topics referenced by the parsed webpage for identifying the parsed webpage as potentially relevant with respect to a semantic query; and
determining whether information in the parsed webpage is duplicative of information in a previously retrieved webpage.
